(19) United States
(12) Patent Application Publication
(10) Pub. No.: US 2008/0049700 A1
(43) Pub. Date: Feb. 28, 2008

(54) Reduced power network association in a wireless sensor network

(76) Inventors: Rahul C. Shah, Beaverton, OR (US); Nandakishore Kushalnagar, Portland, OR (US); Mark D. Yarvis, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/509,857

(22) Filed: Aug. 25, 2006

(51) Int. Cl. H04B 7/216

(52) U.S. Cl. 370/342; 455/425

(57) ABSTRACT

In some embodiments of the invention, an unassociated node in a low-duty-cycle wireless sensor network may determine when the next network operational period begins, so that the node may go into a power-saving sleep mode until the start of that operational period.

### BACKGROUND

Battery-powered wireless sensor networks are increasingly attractive as a way to monitor environmental conditions and periodically transmit the sensed readings through a network of wireless sensor nodes to a central collection point for processing. The wireless feature permits nodes to communicate by radio so they don't need a pre-wired communications infrastructure, the battery power source allows each sensor to be placed in a remote location without access to hard-wired electrical outlets, and the infrequent need to take measurements allows each sensor node to be in sleep mode most of the time to extend its battery life. Since many sensor applications only require measurements be taken and/or communicated infrequently (e.g., hourly, daily, weekly, etc.), the extended periods of sleep can greatly extend battery life. For example, shutting off all or most power in a sensor node except for a wakeup clock circuit may extend useful battery life for months or even years.

However, to periodically transmit the measurements through other nodes requires that clusters of sensor nodes form a network association with each other, and that the associated nodes wake up and communicate with each other on a predetermined schedule so that all will be awake for such communications at the same time. Since such communication may happen very infrequently, and need to be coordinated, every sensor node should be told during an awake period how long to sleep before waking up again. This works well if a network configuration has already been established and remains stable, because each sensor node knows in advance when to wake up. But when a sensor doesn't have the current wakeup schedule (e.g., if a new sensor node is introduced to the network, or an old sensor node loses its wakeup schedule due to battery replacement, reboot, etc.), it may use up significant battery power trying to communicate before the network finally wakes up and provides it with the next wakeup schedule. Finding a way for such a node to associate with a network and obtain the next wakeup schedule without first draining its battery is a common problem in the field.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a cluster controller and wireless network sensor node, according to an embodiment of the invention.

FIG. 2 shows a wireless sensor network, according to an embodiment of the invention.

FIG. 3 shows a timing diagram of various modes and time periods, according to an embodiment of the invention.

FIG. 4 shows a flow diagram of a method of operating a first type of wireless sensor node, according to an embodiment of the invention.

FIG. 5 shows a flow diagram of a method of operating a second type of wireless sensor node, according to an embodiment of the invention.

FIG. 6 shows a flow diagram of a method of operating a cluster controller, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

As used in the claims, unless otherwise specified the use of the ordinal adjectives “first”, “second”, “third”, etc., to describe a common object, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

Various embodiments of the invention let an unsynchronized node in a wireless sensor network go into a low-power sleep mode for much of the time until the next network discovery period starts. When the network discovery period starts, the node may then begin communicating wirelessly with other nodes in the network. An unsynchronized node, sometimes referred to as an ‘orphan’ node, is a node that doesn't know when the next network discovery period starts and therefore doesn't initially know how long it can go into a sleep mode and still be assured of waking up for that next discovery period. In one embodiment the unsynchronized node may alternate between periods of sleep and periods of monitoring for the discovery period, with the duration of these cycles being shorter than a discovery period so that the node will be assured of being awake during at least part of a discovery period. In another embodiment a cluster controller (or other network coordinator) may periodically send out broadcast messages during a network sleep period, the broadcast messages indicating when the next discovery period will begin. An unsynchronized node may monitor until it receives one of these broadcast messages. After receipt of the broadcast message, the node knows when the next discovery period begins, so the node may go into a sleep mode and wake up at the indicated time. The discovery period may, by necessity, include transmissions in both directions between the cluster controller and the sensor nodes. But in some embodiments, the cluster controller may refrain from monitoring for signals from the sensor nodes during the network sleep period.

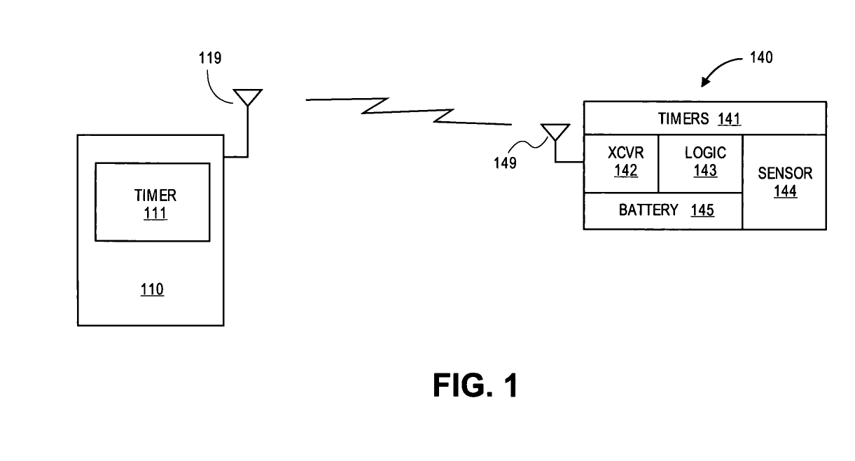

FIG. 1 shows a controller node, which may also be called a cluster controller, and wireless network sensor node, according to an embodiment of the invention. In the illustrated embodiment, a cluster controller 110 may communicate via radio signals with sensor node 140, through antennas 119 and 149, respectively. Each antenna may contain one or more antenna elements. The cluster controller may actually communicate wirelessly with multiple network sensor nodes, but for simplicity of illustration only one sensor node is shown. In some embodiments the cluster controller 110 may be powered from an external source such as AC line power, although other embodiments may use other power sources. Further, in some embodiments cluster controller 110 may have another communications interface to an external network (not shown). This communications interface may take any feasible form, such as but not limited to: 1) a wired communications link, 2) another wireless link using antenna 119 or a different antenna, 3) etc. In this manner, the information produced by the sensor nodes and collected by the cluster controller may be communicated to other systems that may make use of that information. Further, those other systems may provide directions or other information to the sensor network. The cluster controller 110 may contain various components, such as a timer 111 to provide a controlled interval between specific types of transmissions, to be described later in more detail.

Wireless sensor node 140 may also contain various components, such as a transceiver 142, a sensor 144, a battery 145 to power operations of the sensor node, logic 143 to control the various operations of the sensor node, and one or more timers 141 to measure specific time intervals, also to be described later in more detail. The sensor node may be capable of entering a low power sleep mode, in which it is unable to process incoming wireless signals because its receive circuitry is unpowered. In some embodiments, the receive circuitry may be powered but the transmit circuitry unpowered during an operational mode if the node is only monitoring signals, but both the transmit and receive circuitry may be powered for two-way communication. Both the cluster controller 110 and the sensor node 140 may also include other elements as needed, such as but not limited to a digital signal processor, a general-purpose processor, memory, a battery charge indicator, etc.

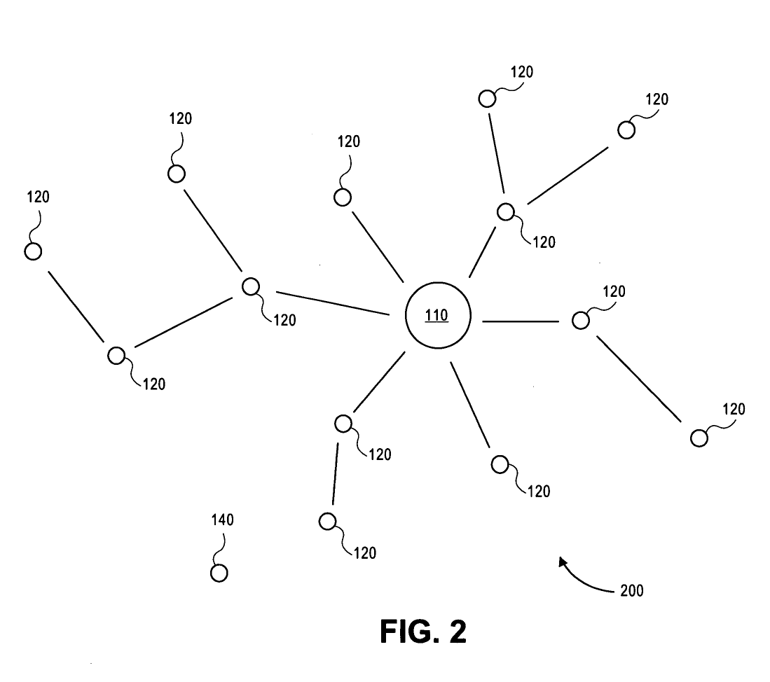

FIG. 2 shows a wireless sensor network, according to an embodiment of the invention. The illustrated network 200 includes a cluster controller 110, multiple synchronized sensor nodes 120, and an unsynchronized sensor node 140. In some embodiments, while the cluster controller may have a wireless transceiver that is powerful enough to transmit to all the sensor nodes, the battery-powered sensor nodes may have a limited transmission range, so that some of them cannot reliably transmit to the cluster controller. These nodes may transmit to other nearby sensor nodes, which can relay the message on to other nodes, with the message eventually reaching the cluster controller (or, in some embodiments which allow node-to-node messages, reaching another sensor node in the network without going through the cluster controller).

During a network sleep period, the synchronized nodes 120 may each be in a low-power sleep mode that doesn't permit them to transmit or receive. In a low power sleep mode, some embodiments turn off the power to most or all of the circuitry in the sensor node, except for a sleep clock that tells the node when to wake up and become operational so that it may then communicate. These sleep/wake periods may be synchronized within the network so that the nodes each wake up at approximately the same time—hence the term ‘synchronized’ for those nodes that know when the next operational period is to start, and thereby know when to wake up. If a node does not know when the next network operational period is to start, it is an ‘unsynchronized’ node. Within the context of this document, this may be the only meaningful distinction between synchronized and unsynchronized nodes. However, in other ways the sensor nodes may be alike or may represent a variety of types, sizes, model numbers, etc.—the synchronized and unsynchronized label applies only to whether they are aware, at a given point during a network sleep period, of the timing of the next network operational period.

In some embodiments, the sleep period may be many times longer that the awake period. For example, a network of temperature sensing nodes may wake up once per hour, spend a few seconds taking temperature measurements and communicating those measurements to the cluster controller, and then go back into sleep mode for another hour.

The potential configuration of the network may change during a sleep period. For example, new sensor nodes may be turned on or added to the area, existing sensor nodes may be turned off or removed from the area, existing sensor nodes may be moved to another location, etc. But with the network in a sleep mode, this change might not be apparent to the cluster controller or to the sensor nodes. For this reason, the beginning of each network operational period may be devoted to determining what nodes are present, and how they should configure communications links so that they can all communicate (directly or indirectly) with the cluster controller. In some embodiments this is termed the discovery period, although various embodiments of the invention are intended to cover devices that use other terminology for this period. The lines shown between various nodes in FIG. 2 indicate one example of such a network configuration of direct communications links, but this configuration might change for the next operational period.

After the discovery period, the network may have a period of querying and data collection (e.g., the cluster controller may request specific information such as sensor readings, and the sensor nodes may report their sensor information back to the cluster controller). The discovery period and the querying and data collection period may be separate periods of time, or they may overlap in time. The discovery period and the querying and data collection period collectively may be referred to as a network operational period, while a period in which the synchronized sensor nodes are in a sleep mode may be referred to as a network sleep period.

At or near the end of a network operational period, the cluster controller 110 may communicate (directly or indirectly) to each node 120 the time at which the next discovery period is to start. In some embodiments this may be communicated by a single broadcast message directed to all nodes, but other embodiments may differ (i.e., a separate message may be directed to each node or to groups of nodes). In some embodiments, each sensor node may rebroadcast the message, allowing it to reach nodes that cannot directly receive messages from the cluster controller 110. The indicated time may be expressed in any of various ways (e.g, a count-down clock value, a time-of-day value, etc.). Using this information, each sensor node 120 may set its sleep clock so that it will wake up at the indicated time. Each node 120 may then go into a sleep mode, knowing that it is synchronized with the other nodes 120, so that they will all wake up for the next discovery period. In some embodiments, nodes may wait for a short period before sleeping, allowing them to receive and forward any messages that are still being repeated among the nodes.

Node 140 is shown as an unsynchronized sensor node, that is, it does not know when the next awake period is to start. A sensor node may be unsynchronized for various reasons (e.g., it was placed into the area during a network sleep period, its batteries were replaced during a sleep period, it was reset or restarted for some reason, etc.). However, unsynchronized node 140 may still be able be spend most of the current network sleep period in a low power sleep mode of its own, and still wake up during the next discovery period, through the techniques described herein.

Note: for simplicity FIG. 2 shows a network with only a single cluster controller, but some embodiments may have multiple cluster controllers in various locations, and some sensor nodes may be within communications range of more than one cluster controller. In such a case, the discovery period may be used to sort out which sensor nodes will be associated with which cluster controller for that particular network operational period. In some embodiments, each sensor node will choose which cluster controller to associate with, but other embodiments may use other techniques. The cluster controller that a particular node associates with during one network operational period may be the same or a different cluster controller than it associated with in a previous network operational period. Discovery activities are known in the industry, and are not described in detail herein, to avoid obscuring the relevant details of embodiments of the invention.

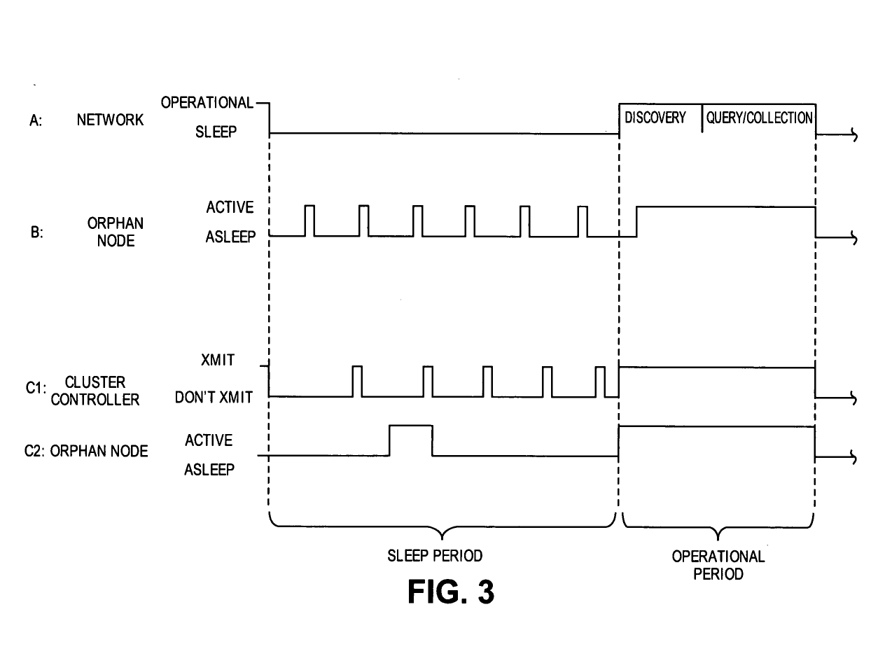

FIG. 3 shows a timing diagram of various modes and time periods, according to an embodiment of the invention. Line A shows a single cycle of one network sleep period and one network operational period, the operational period including the aforementioned discovery period and a query/data collection period. Line B shows the modes of a single orphan node as it tries to become synchronized, according to a first embodiment. In this embodiment, the orphan node, which is initially unsynchronized, will become active and monitor the appropriate wireless channel for received data indicating the network is in a discovery period. If it does not receive such an indication, either because it receives no data or because the data received is not relevant (e.g., a wireless cluster controller might be communicating with another cluster controller during a network sleep period), then the orphan node may enter a sleep period in which it cannot detect received data because some or all of the necessary circuitry is a non-operational low power mode. After a pre-determined time period, the orphan node may waken and again monitor for an indication the network is in a discovery period. The illustrated example shows six such periods of monitoring before the orphan node finally detects the network is in a discovery period during the seventh attempt. In some embodiments, the sensor node may power up its receive circuitry during the monitoring period but leave its transmit circuitry unpowered to further reduce total power consumption.

To achieve a balance between reliable detection and significant power savings, the duration of the monitoring period may be long enough to assure accurate detection if a discovery period is in progress, but not much longer than that. The duration of the orphan node's sleep period between monitoring operations should be shorter than the discovery period, to assure that the orphan node does not miss the discovery period by sleeping through it.

Once the orphan node detects that the network is in a discovery period, the node may remain active so it may participate in the discovery and the querying and data collection activities of the network. Before the network enters another network sleep period, the node may receive data from the cluster controller indicating when the next network operational period will begin. At that point, the sensor node will no longer be considered unsynchronized, and may sleep throughout the next network sleep period without further monitoring.

Lines C1 and C2 show a second embodiment. In this embodiment, during the network sleep period the cluster controller may periodically transmit a message containing an indicator of when the next network operational period will start. When a sensor node is activated during the network sleep period, it only needs to monitor until the next such transmission from the cluster controller. After receiving that transmission, the sensor node knows how long to sleep until the next operational period, and can enter a sleep mode for that period of time.

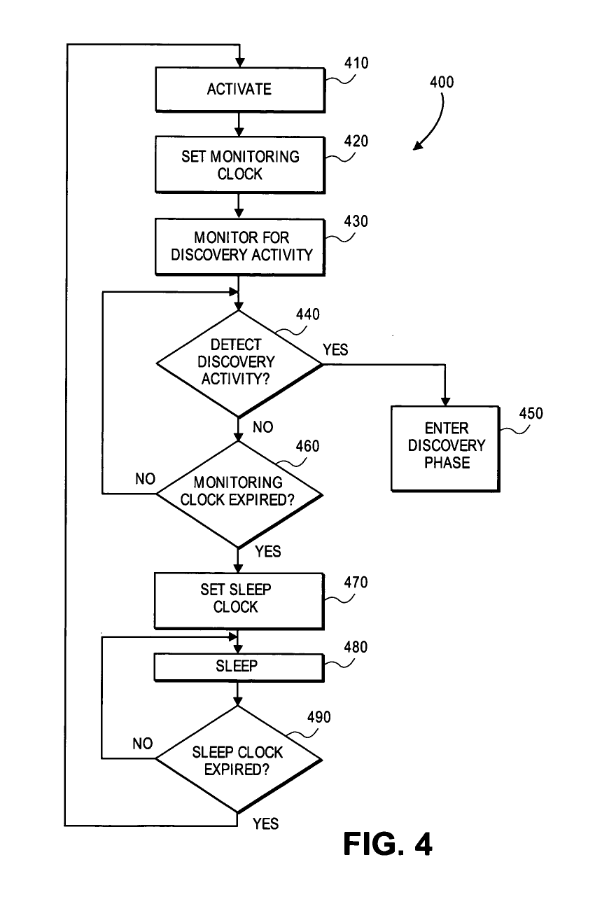

FIG. 4 shows a flow diagram of a method of operating a first type of wireless sensor node, according to an embodiment of the invention. This method corresponds to the operations indicated by line B of FIG. 3. The operations of flow diagram 400 may begin when a wireless sensor node is activated at 410. To begin listening for a received message containing a time indicator that will allow the sensor node to become synchronized within a network, the sensor node may set a monitoring clock at 420 and begin monitoring at 430 for received signals indicating the network is in a discovery period. The monitoring clock may be set to expire after a pre-determined period of monitoring. If the node detects discovery activity at 440, it may proceed to enter the discovery phase itself at 450. This may involve various communications activities with a cluster controller (either directly or indirectly through other nodes) that make this sensor node part of a defined network of nodes.

If discovery activity is not detected at 440, the sensor node will continue to monitor until such activity is detected, or until the monitoring clock expires at 460. When the monitoring clock expires, the node may set a sleep clock at 470 to a time period the node is to sleep before beginning to monitor again. The node may then put itself into a low power sleep mode until the sleep clock expires, as indicated at 480 and 490. At the expiration of the sleep clock, the node may become activated at 410 and the entire cycle may repeat itself until discovery activity is finally detected and the node enters the discovery phase at 450. In normal operation, discovery should be detected within a determinable number of cycles. In abnormal operation (for example, the node is activated when there is no network within communications range), in some embodiments the node may try to preserve battery power by shutting down after a predetermined number of cycles with no detection of discovery activity, but other embodiments may use other techniques.

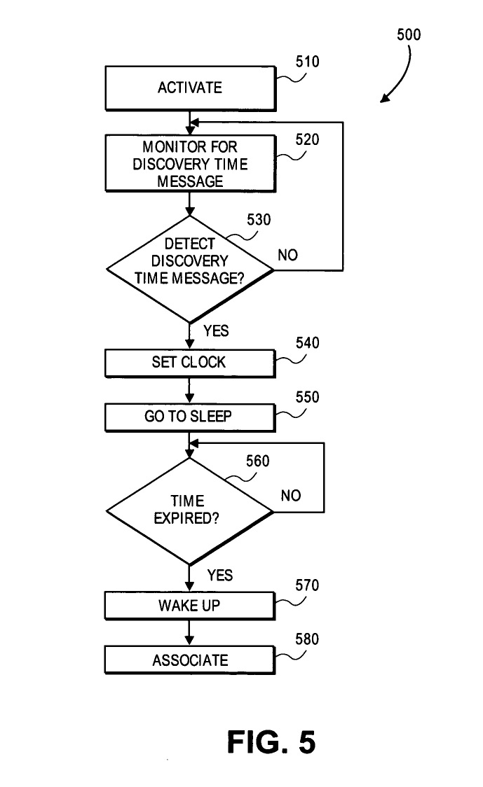

FIG. 5 shows a flow diagram of a method of operating a second type of wireless sensor node, according to an embodiment of the invention. This method corresponds to the operations indicated by line C2 of FIG. 3. The operations of flow diagram 500 may begin when a wireless sensor node is activated at 510. To begin searching for a time indicator that will allow the sensor node to become synchronized within a network, the sensor node may begin monitoring at 520 for received signals indicating when the network will enter a discovery period. This monitoring may continue until such a message is received, as determined at 530. The time indicator received in that message may be used to set a clock at 540, which will expire at the indicated time. The node may then go into a low power sleep mode at 550, and remain in that mode until the clock expires as indicated at 560. Once the clock expires, the node may wake up at 570. The network discovery period should then be in effect, and the node may go through whatever operations are needed to associate itself with the network at 580. Although not shown, if the sensor node detects at 530 that the network is already in a discovery period, the node may go directly to 580.

In normal operation, either a discovery time message or the discovery period itself should be detected at 530 within a predetermined time. In abnormal operation (for example, the node is activated when there is no network within communications range), in some embodiments the node may try to preserve battery power by shutting down if neither condition is detected within a certain time period, but other embodiments may use other techniques.

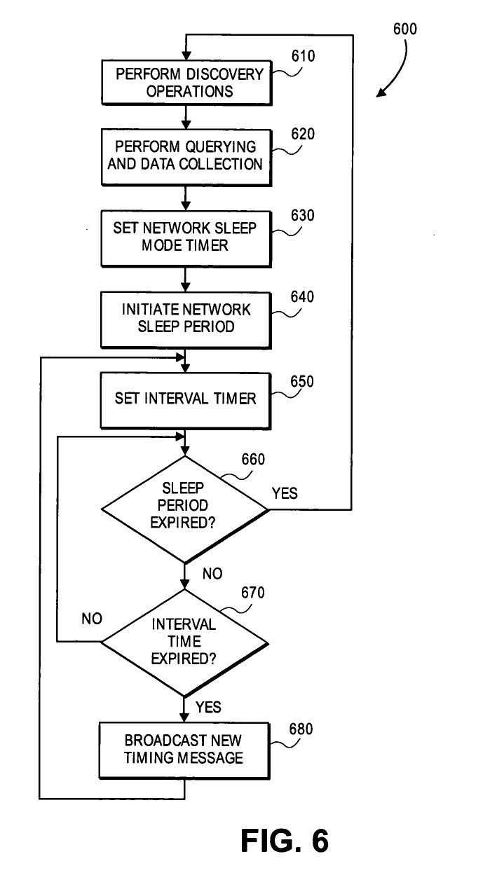

FIG. 6 shows a flow diagram of a method of operating a cluster controller, according to an embodiment of the invention. This method corresponds to the operations indicated by line C1 of FIG. 3. The operations of flow diagram 600 may begin during a network operational period, when the cluster controller performs discovery operations at 610, and performs querying and data collection operations at 620. Although these are shown sequentially, in some embodiments these two network operations may overlap in time. The cluster controller may determine when the next sleep period will end and the subsequent discovery period will begin, and set an internal clock at 630 to measure that intervening time. The cluster controller may then initiate a network sleep mode at 640 by sending out a network sleep time indicator to all the sensor nodes in the network, indicating the duration of the upcoming network sleep period.

During the network sleep period, the cluster controller may periodically broadcast a message indicating when the start of the next discovery period will occur. In preparation for this, the cluster controller may set an interval timer at 650. During the network sleep period, if the interval timer expires at 670, the cluster controller may broadcast, at 680, the message that indicates when the next discovery period will start, and then reset the interval timer at 650 to begin another interval. This broadcast message might be transmitted many times during a single network sleep period, depending on how the various timing parameters are set. At some point the network sleep period will end, as detected at 660, and the next discovery period will actually start. As previously described for FIG. 5, a sensor node that received the broadcast timing message will know to wake up at that time and take part in the discovery process.

The previous paragraphs describe two types of processes, each of which takes place mostly during a network sleep period. In the first type, an orphan node goes through multiple cycles of monitoring/sleeping, until it detects the network is in the discovery phase of a network operational period. Such a process may work without any special support from the cluster controller. In the second type, the cluster controller periodically broadcasts a message indicating when the next network operational period will begin. The orphan node can simply monitor until it detects such a message, and then go into a sleep mode until the indicated time. However, some embodiments may combine these two processes in a single hybrid sensor node. In such an embodiment, a sensor node may go through the cycles of monitoring/sleeping as in the first type. If it detects a message during one of the brief monitoring periods that indicates when the next network operational period will begin, it may then go into a sleep mode until such time. If it does not detect such a message, it may keep cycling until it either: 1) does detect such a message, or 2) detects the actual network operational period. A separate flow diagram for this hybrid approach has not been provided because the simplicity of understanding such a combination from the other drawings precludes the need for it.

The foregoing description is intended to be illustrative and not limiting. Variations will occur to those of skill in the art. Those variations are intened to be included in the various embodiments of the invention, which are limited only by the spirit and scope of the following claims.

What is claimed is:

1. An apparatus, comprising
a sensor node for a wireless sensor network, the sensor node to:
monitor, during a network sleep period for the wireless sensor network, for received wireless signals containing information pertaining to an operational mode for the wireless sensor network; and
enter, subsequent to said monitoring and prior to the wireless sensor network entering the operational mode, a sleep mode in which the sensor node cannot monitor for the received signals.

2. The apparatus of claim 1, wherein:
the information includes an indicator that the network is already in the operational mode;
the sensor node is to repeat the operations of monitoring and entering until the sensor node receives the wireless signals containing the information; and
the sensor node is to perform discovery operations subsequent to said receiving the wireless signals containing the information.

3. The apparatus of claim 2, wherein a combination of a single monitor period plus a subsequent single sleep mode period is less than a single discovery period for the network.

4. The apparatus of claim 1, wherein:
the information includes an indicator of a time when the network operational mode is to start;
the sensor node is to continue the operation of monitoring until the sensor node receives the wireless signal containing the information;
the sensor node is to remain in the sleep mode until approximately the time when the wireless sensor network is to enter the operational mode; and
the sensor node is to perform discovery operations while the network is in the operational mode.

5. The apparatus of claim 1, wherein the wireless sensor node comprises a radio transceiver, and a battery coupled to the radio transceiver.

6. The apparatus of claim 1, wherein the wireless sensor node comprises a radio transceiver, and a sensor coupled to the radio transceiver.

7. An apparatus, comprising
a controller node for a wireless sensor network, the controller node to:
transmit to sensor nodes in the wireless sensor network, during a first network operational period, at least one indicator of a time period for a network sleep mode to occur subsequent to the network operational period; and
transmit, during the time period for the network sleep mode, at least one message containing an indicator of a remaining time period until a second network operational period.

8. The apparatus of claim 7, wherein the controller node is further to not monitor for wireless signals from the sensor nodes during the time for the network sleep mode.

9. The apparatus of claim 7, wherein the controller node is further to monitor for wireless signals from the sensor nodes during the network operational periods.

10. A method, comprising:
placing a wireless sensor node into a first operational mode for a first period of time, the operational mode being a mode in which the node is able to process incoming radio signals;
placing the wireless sensor node in a low power mode for a second period of time subsequent to the first period of time, the low power mode being a mode in which the node is unable to process the incoming radio signals; and
placing the wireless sensor node into a second operational mode for a third period of time subsequent to the second period of time;
wherein the first and second periods of time occur during a network sleep period and the third period of time occurs during a network operational period.

11. The method of claim 10, further comprising:
repeating the operations of placing the wireless sensor node in a first operational mode and placing the wireless sensor node in a low power mode, until the wireless sensor node receives, during one of the first operational modes, a radio signal containing an indicator of when the network is to enter the network operational period; and
placing the wireless sensor node into the low power node, subsequent to said receiving, until the network enters the network operational period.

12. The method of claim 11, further comprising performing discovery operations during the network operational period.

13. The method of claim 10, further comprising:
keeping the wireless sensor node in the first operational mode until the wireless sensor node receives a wireless signal containing an indicator of when the network is to enter the network operational period; and
keeping the wireless sensor node in the low power mode until the time indicated by the indicator.

14. The method of claim 13, further comprising performing discovery operations during the network operational period.

15. A method comprising:
transmitting at least one wireless message to multiple wireless sensor nodes in a network, directing the wireless sensor nodes to enter a low power sleep mode until the end of a predetermined time period; and
transmitting additional messages during the predetermined time period, the additional messages containing an updated indication of when the predetermined time period is to end.

16. The method of claim 15, further comprising:
entering a network operational period subsequent to the predetermined time period, and
wirelessly communicating with the sensor nodes during the network operational period.

17. An article comprising
a tangible machine-readable medium that contains instructions, which when executed by one or more processors result in performing operations comprising:
placing a wireless sensor node into a first operational mode for a first period of time, the operational mode being a mode in which the node is able to process incoming radio signals;
placing the wireless sensor node in a low power mode for a second period of time subsequent to the first period of time, the low power mode being a mode in which the node is unable to process the incoming radio signals; and
placing the wireless sensor node into a second operational mode for a third period of time subsequent to the second period of time;
wherein the first and second periods of time occur during a network sleep period and the third period of time occurs during a network operational period.

18. The article of claim 17, wherein the operations further comprise:
repeating the operations of placing the wireless sensor node in a first operational mode and placing the wireless sensor node in a low power mode, until the wireless sensor node receives, during one of the first operational modes, a radio signal containing an indicator of when the network is to enter the network operational period; and
placing the wireless sensor node into the low power node, subsequent to said receiving, until the network enters the network operational period.

19. The article of claim 18, wherein the operations further comprise performing discovery operations during the network operational period.

20. The article of claim 18, wherein the operations further comprise placing transmit circuitry in a low power state in the first operational mode.

21. The article of claim 17, wherein the operations further comprise:
keeping the wireless sensor node in the first operational mode until the wireless sensor node receives a wireless signal containing an indicator of when the network is to enter the network operational period, and
keeping the wireless sensor node in the low power mode until the time indicated by the indicator.

22. The article of claim 21, wherein the operations further comprise performing discovery operations during the network operational period.

23. An article comprising
a tangible machine-readable medium that contains instructions, which when executed by one or more processors result in performing operations comprising:
transmitting at least one wireless message to multiple wireless sensor nodes in a network, directing the wireless sensor nodes to enter a low power mode for a predetermined time period; and
transmitting additional messages during the predetermined time period, the additional messages containing an indication of when the predetermined time period is to end.

24. The article of claim 23, wherein the operations further comprise:
entering a network operational period subsequent to the predetermined time period; and
wirelessly communicating with the sensor nodes during the network operational period.
